(19) United States
(12) Patent Application Publication
(10) Pub. No.: US 2022/0063249 A1
(43) Pub. Date: Mar. 3, 2022

(54) RESIN LAYER, LAMINATING INTERLAYER, LIGHT TRANSMITTING LAMINATE AND VEHICLE

(71) Applicant: SKC Co., Ltd., Suwon-si (KR)

(72) Inventors: Hyejin KIM, Suwon-si (KR); Haksoo LEE, Suwon-si (KR); Kyuhun KIM, Suwon-si (KR); Sungjin CHUNG, Suwon-si (KR)

(73) Assignee: SKC Co., Ltd., Suwon-si (KR)

(21) Appl. No.: 17/458,801

(22) Filed: Aug. 27, 2021

(30) Foreign Application Priority Data
Sep. 1, 2020 (KR) 10-2020-0110769

(51) Int. Cl. B32B 17/10; B29C 48/00; B29C 48/08; C09J 7/10; C09J 7/35; C09J 11/06; B60J 1/00

(52) U.S. Cl. CPC B32B 17/10761; B29C 48/022; B29C 48/08; C09J 7/10; B29K 2031/04; C09J 11/06; B60J 1/001; B32B 2605/006; C09J 7/35

(57) ABSTRACT

Example embodiments provide a resin layer, a light transmitting laminate, and a vehicle. The resin layer includes at least one laminating layer containing a polyvinyl acetal resin, a plasticizer, and a bonding strength modifier. The surface of the laminating layer includes a portion having a hydrophobicity of 3.5 to 10, as calculated by Equation 1:

Hydrophobicity=Non-polarity/polarity (1)
where the non-polarity represents the non-polar fraction of the surface free energy of the laminating layer and the polarity represents the polar fraction of the surface free energy of the laminating layer.

The resin layer has good shelf moisture resistance, undergoes less change in yellowness index, and has effectively controllable bonding strength due to its controlled hydrophobicity.

This application claims the benefit under 35 USC 119(a) of Korean Patent Application No. 10-2020-0110769 filed on Sep. 1, 2020, in the Korean Intellectual Property Office, the entire disclosures of which are incorporated herein by reference for all purposes.

### BACKGROUND

### 1. Field

Example embodiments relate to a resin layer with controlled hydrophobicity, and more specifically to a resin layer that has good shelf moisture resistance, ensuring less variation in yellowness index and effective control over bonding strength. Other example embodiments relate to a laminating interlayer including the resin layer, a light transmitting laminate including the laminating interlayer, and a vehicle including the light transmitting laminate.

### 2. Related Art

Safety glass has been widely used in construction and automotive applications. Safety glass is typically used in the form of laminated glass in which a laminating layer containing a plasticized polyvinyl acetal resin is bonded to glass or a laminate of a plastic substrate (for example, a polyester film) and two or more resin layers is bonded to glass.

Safety glass should be excellent in penetration resistance and impact resistance while possessing high transparency and durability and good moisture resistance, water resistance, and adhesiveness. That is, even when breakage of safety glass is caused by an impact, the laminated interlayer should not be penetrated. Glass should firmly adhere to the interlayer to minimize the scattering of glass pieces upon breakage. Safety glass is required to undergo less change in performance in response to environmental conditions such as temperature and humidity. These requirements are necessary for safety to protect people in vehicles and buildings against external impacts or to prevent glass from being peeled off from light transmitting laminates and causing secondary injuries while protecting people from glass fragments scattering from broken glass.

The bonding strength between glass and a resin layer needs to be controlled within a certain range. If the bonding strength between the glass and the laminating interlayer is excessively low, the glass may be peeled off from the laminating interlayer when broken by an impact. Meanwhile, if the bonding strength between the glass and the laminating interlayer is excessively high, the laminating interlayer as well as the glass is broken, and as a result, the tempered glass may be easily penetrated.

### PRIOR ART DOCUMENTS

### Patent Documents

U.S. Pat. No. 5,728,472, entitled “CONTROL OF ADHESION OF POLYVINYL BUTYRAL SHEET TO GLASS”, which was registered on Mar. 17, 1998 (but currently extinguished).

Japanese Patent Publication No. 2002-097041, entitled “INTERMEDIATE FILM FOR LAMINATED GLASS AND LAMINATED GLASS”, which was published on Apr. 4, 2002.

Japanese Patent No. 2999177, entitled “INTERMEDIATE FILM FOR LAMINATED GLASS AND LAMINATED GLASS”, which was registered on Nov. 5, 1999.

### SUMMARY

One object of example embodiments is to provide a resin layer with controlled hydrophobicity that has good shelf moisture resistance, ensuring less variation in yellowness index and effective control over bonding strength. A further object of example embodiments is to provide a laminating interlayer including the resin layer. Another object of example embodiments is to provide a light transmitting laminate including the laminating interlayer.

A resin layer according to example embodiments disclosed herein includes at least one laminating layer containing a polyvinyl acetal resin, a plasticizer, and a bonding strength modifier wherein a surface of the laminating layer includes a portion having a hydrophobicity of 3.5 to 10, as calculated by Equation 1:

Hydrophobicity=Non-polarity/polarity (1)

where the non-polarity represents a non-polar fraction of a surface free energy of the laminating layer and the polarity represents a polar fraction of the surface free energy of the laminating layer.

The laminating layer may have two or more peaks in the detection time range of 26 to 28 minutes (RT) in an ultraviolet detector (UVD) of a gel permeation chromatography (GPC) system.

The laminating layer has a shelf yellowness index difference of less than 2, as calculated by Equation 2:

Shelf yellowness index difference=Shelf_YI_B−Shelf_YI_A (2)

where Shelf_YI_B represents a yellowness index of the laminating layer measured by the ASTM E313 method after storage at 30° C. and 80% RH for 30 days and Shelf_YI_A represents a yellowness index of the laminating layer measured by the ASTM E313 method after storage at 20° C. and 20% RH for 30 days.

The laminating layer has a shelf moisture resistance of 0 to 4, as calculated by Equation 3:

Shelf moisture resistance=(Shelf yellowness index difference)×100/Metal content (3)

where the metal content represents a content (ppm) of a metal in the laminating layer.

The laminating layer may have an effective bonding strength reduction of 5 to 15, as calculated by Equation 4:

Effective bonding strength reduction={8−P_ctr (pummel value)}×100/metal content (4)

where P_ctr is a pummel value of the laminating layer and the metal content is a content (ppm) of a metal in the laminating layer.

The resin layer may have a yellowness index variation of 3.0 or less before and after storage in a thermo-hygrostat chamber at 65° C. and 95% RH for 2 weeks.

The resin layer may have an average whitening distance variation of 5 mm or less, as measured before and after storage at 65° C. and 95% RH for 2 weeks.

The resin layer may be used as a laminating interlayer.

The resin layer may be used as an interlayer for a laminated glass.

A laminating interlayer according to example embodiments disclosed herein includes the above-described resin layer.

A light transmitting laminate according to example embodiments disclosed herein includes the above-described laminating interlayer.

A vehicle according to example embodiments disclosed herein includes the above-described light transmitting laminate as a windshield.

The resin layer, the laminating interlayer including the resin layer, and the light transmitting laminate of example embodiments have good shelf moisture resistance, undergo less change in yellowness index, and have effectively controllable bonding strengths due to their controlled hydrophobicity.

### BRIEF DESCRIPTION OF THE DRAWINGS

Example embodiments may be more clearly understood from the following detailed description in conjunction with the accompanying drawings in which:

FIG. 1 is a cross-sectional view illustrating a light transmitting laminate using a resin layer according to one embodiment;

FIG. 2 is a cross-sectional view illustrating a light transmitting laminate using a resin layer according to a further embodiment;

FIG. 3 illustrates the measurement of whitening distances; and

FIG. 4 shows gel permeation chromatograms of samples taken from resin layers of Example 2 (EX2, left) and Comparative Example 1 (C.EX1, right) in the detection time range of 26 to 28 minutes.

### DETAILED DESCRIPTION OF EXAMPLE EMBODIMENTS

Reference will now be made in detail to example embodiments, examples of which are illustrated in the accompanying drawings such that they can easily be made by those skilled in the art. Example embodiments may, however, be embodied in many different forms and should not be construed as limited to exemplary embodiments set forth herein. Like reference numerals indicate like elements throughout the specification and drawings.

As used herein, the terms “about”, “substantially”, etc. are intended to allow some leeway in mathematical exactness to account for tolerances that are acceptable in the trade and to prevent any unconscientious violator from unduly taking advantage of the disclosure in which exact or absolute numerical values are given so as to help understand example embodiments.

Throughout the present specification, the term “combination of” included in Markush type description means mixture or combination of one or more elements described in Markush type and thereby means that the disclosure includes one or more elements selected from the Markush group.

Throughout the present specification, the terms “first” and “second” or “A” and “B” are used to distinguish one element from another. A singular representation may include a plural representation as far as it represents a definitely different meaning from the context.

In the present specification, the term “˜-based compound” is intended to include compounds corresponding to “˜” or derivatives of “˜”.

In the present specification, it will be understood that when “B” is referred to as being on “A”, “B” can be directly on “A” or intervening layers may be present therebetween. That is, the location of “B” is not construed as being limited to direct contact of “B” with the surface of “A”.

In the present specification, ppm is by weight.

In the present specification, the singular forms “a,”, “an,” and “the” are intended to include the plural forms as well, unless context clearly dictates otherwise.

In the present specification, the amount of hydroxyl groups is evaluated by measuring the amount of ethylene groups to which the hydroxyl groups of a polyvinyl acetal resin are bonded, in accordance with the procedure of JIS K6728.

The inventors have found that a resin layer with controlled hydrophobicity has good shelf moisture resistance, ensuring less variation in yellowness index and effective control over bonding strength. Example embodiments have been accomplished based on this finding.

Embodiments will now be described in more detail.

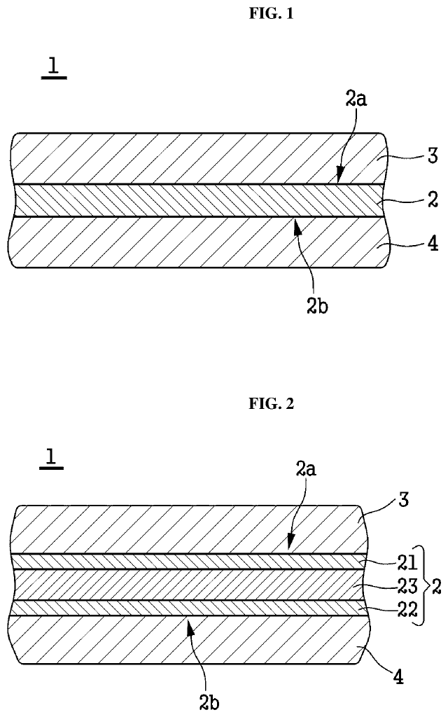

FIG. 1 is a cross-sectional view illustrating a light transmitting laminate using a resin layer according to one embodiment and FIG. 2 is a cross-sectional view illustrating a light transmitting laminate using a resin layer according to a further embodiment. A more detailed description of example embodiments will be given with reference to FIGS. 1 and 2.

Example embodiments provide a laminating interlayer having a resin layer that has good shelf moisture resistance, undergoes less change in yellowness index, and has an effectively controllable bonding strength due to its controlled hydrophobicity.

A resin layer according to example embodiments disclosed herein includes a laminating layer including a surface portion whose hydrophobicity is 3.5 to 10.

Specifically, the hydrophobicity of the laminating layer may be in the range of 3.5 to 8, 3.5 to 6, 4 to 8, or 4 to 6. Within this range, the resin layer may have a small shelf yellowness index difference and at the same time have good shelf moisture resistance.

Specifically, the hydrophobicity is defined as a value obtained by dividing the dispersion component (“non-polarity”) of the surface free energy by the polar component (“polarity”) of the surface free energy in the surface energy of the resin layer or the laminating layer calculated by the geometric mean combining rule and measured using a surface energy measurement system.

For example, the hydrophobicity may be calculated from the surface energy measured using a mobile surface analyzer (MSA), which is available from KRUSS. Specifically, the surface energy may be measured using a surface energy measurement system at 4 seconds after dropping 1 microliter of a solvent. Water is selected as a polar solvent and methylene iodide is selected as a non-polar solvent. The surface energy may be calculated by the geometric mean combining rule. For example, the measurements of surface energy, non-polarity, and polarity may be conducted by the Owens, Wendt, Rabel and Kaelble (OWRK) method. The hydrophobicity can be accurately calculated by selecting different sites on the surface of the same specimen, repeatedly evaluating the hydrophobicity values of the selected sites 5 times or more, and averaging the values of 3 sites other than the upper and lower limits.

The characteristics of the laminating layer can be determined through a curve obtained using an ultraviolet detector (UVD) of a gel permeation chromatography (GPC) system. The gel permeation chromatography system is used to measure molecular weights. The detection of a material at a specific elution time appears as a peak and different elution times (i.e. different peak locations) indicate the presence of materials with different characteristics. Peaks in the gel permeation chromatogram can be ascribed to the presence of a resin, a plasticizer, an additive, and other materials and are even attributable to the presence of decomposition by-products of materials by heat and friction. Accordingly, it is important to determine significant elution times for a better analysis of results. Limited elution times in the determined range can distinguish the characteristics of example embodiments and enable better analysis of results.

Specifically, the elution times may be in the range of 26 to 30 minutes, 26 to 29 minutes, or 26 to 28 minutes. The elution time can be determined by the following procedure. First, 0.1 g of a sample is diluted with 10 g of THF. The dilution is allowed to stand at room temperature for 12 h to sufficiently dissolve and homogenize the sample. 100 microliters of the solution is loaded onto a column at a rate of 1.0 ml/min. The elution time is calculated from when a UV detector is operated at 230 nm and 40° C.

The column may be an assembly of TSKgel guard column (6.0 mm ID×4 cm, particle size 7 μm), TSKgel G1000HXL (7.8 mm ID×30 cm, particle size 5 μm, exclusion limit 1,000 Da), TSKgel G2500HXL (7.8 mm ID×30 cm, particle size 5 μm, exclusion limit 2.0×10⁴ Da), and TSKgel G3000HXL (7.8 mm ID×30 cm, particle size 5 μm, exclusion limit 6.0×10⁴ Da), all of which are available from TOSOH. The measured values are analyzed and plotted using Agilent Chemstation OpenLab. CDS.

Specifically, the obtained curve may have two or more peaks in the elution time range wherein the intensity of the first peak may be larger than that of the second peak. The peak observed at the earlier detection time (i.e. the time close to 26 minute) is defined as the first peak. In this way, the order of the first and second peaks is determined. This feature ensures good shelf moisture resistance of the laminating layer and less variation in the yellowness index of the laminating layer.

The laminating layer has a shelf yellowness index difference not greater than 2.

Specifically, the laminating layer may have a shelf yellowness index difference of less than 2.

The shelf yellowness index difference is a value obtained by subtracting the yellowness index of the laminating layer after storage in a low temperature and low humidity environment from that after storage in a high temperature and high humidity environment. The shelf yellowness index difference increases with increasing yellowness index variation in a high temperature and high humidity environment, indicating poor durability of the laminating layer in a high temperature and high humidity environment where moisture penetration is more likely to occur.

The yellowness index can be measured by the ASTM E313 testing standard. The yellowness index of a film having surface irregularities can be more accurately measured after removal of the surface pattern by heating. In the case where the laminating layer is in the form of a film having irregularities, base films whose surfaces are flat are placed on both surfaces of the laminating layer, followed by heating under pressure to remove the pattern. The base films may be polyester films or Teflon sheets that can be easily peeled off from the laminating layer (film). In the case of a sample in which the laminating layer (film) is bonded to a substrate such as glass, the glass and the laminating layer (film) are separated from each other, the laminating layer (film) is formed into a film whose thickness is made constant in a hot press, and the yellowness index of the film is measured. The shelf moisture resistance of the laminating layer (film) may be of 4 or less, 3.5 or less, 3.3 or less, or 3.0 or less. The shelf moisture resistance of the laminating layer (film) may be 0 or more, 0 or more, 0.5 or more, or 1 or more.

The shelf moisture resistance is defined as a value calculated by dividing the shelf yellowness index difference by the metal content of the resin layer.

The metal content can be measured by ion coupled plasma (ICP) analysis. Pretreatment for ion coupled plasma analysis may be performed by suitable methods, including but not particularly limited to, furnace methods and microwave methods. The metal content may be calculated from a ratio of the total molecular weight of all molecules to the molecular weight of a metal in the amount of a bonding strength modifier added. Alternatively, the metal content may be determined by sampling a small portion of the laminating layer and measuring the content of a metal in the sample by ion coupled plasma analysis. A shelf moisture resistance of more than 4 means that the metal content significantly affects an increase in the shelf yellowness index, indicating that the yellowness index in a high temperature and high humidity environment is high.

The effective bonding strength reduction of the laminating layer may be 5 or more. The effective bonding strength reduction may be 5 to 15, 5 to 13, or 5 to 12. If the effective bonding strength reduction is lower than 5, the metal content has little effect in controlling the bonding strength. The addition of an excessive amount of a bonding strength modifier can achieve a desired effective bonding strength reduction but may cause poor shelf moisture resistance, deteriorating performance (e.g., increasing a whitening distance) of laminated glass.

A resin layer 2 according to one embodiment disclosed herein comprises at least one laminating layer comprising a polyvinyl acetal resin, a plasticizer, and a bonding strength modifier.

The resin layer 2 may comprise a single laminating layer (see FIG. 1). Alternatively, the resin layer 2 may have a multilayer structure comprising three or more layers (see FIG. 2). In this case, a first laminating layer 21 sharing one surface of the resin layer 2 and a second laminating layer 22 opposite the first laminating layer and sharing the other surface of the resin layer 2 may be in direct contact with a first light transmitting layer 3 and a second light transmitting layer 4, respectively. The laminating layer refers collectively to the first laminating layer 21 and the second laminating layer 22.

The bonding strength modifier may be selected from the group consisting of, but not limited to, metal salts, alkaline earth metals, metal complexes, and combinations thereof.

Specifically, the metal salt may be selected from magnesium carboxylates, potassium carboxylates, sodium carboxylates, magnesium complexes, potassium complexes, and sodium complexes. The metal salt may be a metal complex represented by Formula 1:

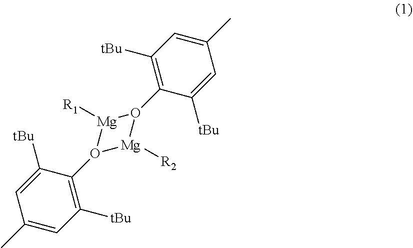

wherein R₁ and R₂ are each independently selected from the group consisting of hydrogen, C₁-C₁₀ alkyl, C₁-C₁₀ alkenyl, C₁-C₁₀ alkoxy, C₁-C₈ carboxyl, C₄-C₁₂ cycloalkyl, and C₆-C₁₂ aryl.

Specifically, R₁ and R₂ in Formula 1 are each independently selected from the group consisting of hydrogen, C₁-C₅ alkyl, C₁-C₅ alkenyl, C₁-C₅ alkoxy, C₁-C₅ carboxyl, C₄-C₈ cycloalkyl, and C₆-C₁₀ aryl.

Due to its bulky three-dimensional structure, the butylated hydroxytoluene type metal complex induces steric hindrance by the chelate structure at the interfaces 2a and 2b of the resin layer 2 and more effectively impedes laminating between the hydroxyl groups of the polyvinyl acetal resin present in the resin layer and functional groups —Si—OH located on the surfaces of the light transmitting layers 3 and 4 such as glass plates, enabling efficient control over bonding strength.

Since the functional groups of the metal complex represented by Formula 1 have low electronegativities and low polarities compared to those of conventional bonding strength modifiers such as carboxylates, the metal complex represented by Formula 1 enables efficient control over the hydrophobicity of the resin layer and at the same time improves the moisture resistance of the resin layer.

The bonding strength modifier may be present in an amount of 0.0001 to 1% by weight or 0.001 to 0.7% by weight, based on the total amount of the laminating layer. The presence of the bonding strength modifier in the amount defined above is effective in controlling the bonding strength to an appropriate level and prevents the deterioration of moisture resistance and/or durability possibly caused by the bonding strength modifier.

The bonding strength modifier in the form of a metal complex may be added to a composition for forming the laminating layer comprising the polyvinyl acetal resin and the plasticizer during formation of the resin layer comprising the laminating layer. Alternatively, after addition of a butylated hydroxytoluene (or a derivative thereof) and magnesium (magnesium ions or a compound containing magnesium ions) to a composition for forming the laminating layer during formation of the resin layer, their reaction may be induced to form a metal complex as the bonding strength modifier in the laminating layer.

The resin layer 2 may comprise an ultraviolet (UV) absorber in addition to the bonding strength modifier comprising the metal complex. The bonding strength modifier may be present in the laminating layer and the UV absorber may be present in the laminating layer and/or one or more portions of the resin layer other than the laminating layer. The UV absorber functions to improve the weather resistance of the resin layer 2. Specifically, the UV absorber can prevent the durability of the resin layer from deterioration resulting from an increase in yellowness index.

The resin layer 2 may comprise a benzotriazole compound as the UV absorber.

Specifically, the laminating layer (or resin layer) may comprise 0.01 to 3% by weight or 0.05 to 1% by weight of the benzotriazole UV absorber, based on its total weight. If the laminating layer (or resin layer) comprises less than 0.01% by weight of the UV absorber, the effect of the UV absorber is negligible. Meanwhile, if the laminating layer (or resin layer) comprises more than 3% by weight of the UV absorber, the resin layer may be yellowed.

The weight ratio of the metal complex to the benzotriazole UV absorber in the laminating layer (or resin layer) may be in the range of 1:10 to 30 or 1:15 to 20. Within this range, the laminating layer (or resin layer) can be more efficiently prevented from yellowing, which may occur over time as a result of possible chemical reactions between the benzotriazole UV absorber and the other materials present in the laminating layer, and its durability can be further improved.

The polyvinyl acetal resin is a thermoplastic resin that serves as a base resin for the laminating layer. The kind of the polyvinyl acetal resin is not limited.

The polyvinyl acetal resin present in the resin layer has an adhesive strength to the light transmitting layers 3 and 4 to help bonding between the resin layer 2 and the light transmitting layers 3 and 4 and constitute a light transmitting laminate 1. The light transmitting layers may be, for example, glass plates, laminating members, or other films.

The polyvinyl acetal resin may be prepared by acetalizing a polyvinyl alcohol with an aldehyde. The polyvinyl acetal resin is preferably an acetalization product of a polyvinyl alcohol. The polyvinyl alcohol may be obtained by saponification of a polyvinyl acetate. The degree of saponification of the polyvinyl alcohol is typically in the range of 70 to 99.9% by mole. The polyvinyl alcohol may have an average degree of polymerization of 1,600 to 3,000 or 1,700 to 2,500. When the average degree of polymerization is equal to or greater than the lower limit, a penetration resistance of the light transmitting laminate can be further enhanced. Meanwhile, when the average degree of polymerization is equal to or less than the upper limit, the laminating layer can be easily formed into a film. The average degree of polymerization of the polyvinyl alcohol is calculated by JIS K6726 “Test method for polyvinyl alcohol”.

The aldehyde is not particularly limited. The aldehyde is typically one having 1 to 10 carbon atoms. Examples of such C₁-C₁₀ aldehydes comprise propionaldehyde, n-butyraldehyde, isobutyraldehyde, n-valeraldehyde, 2-ethylbutyraldehyde, n-hexylaldehyde, n-octylaldehyde, n-nonylaldehyde, n-decylaldehyde, formaldehyde, acetaldehyde, and benzaldehyde, which may be used as single one or as a mixture of two or more thereof.

The content (or amount) of hydroxyl groups in the polyvinyl acetal resin may be at least 15% by weight or at least 17% by weight but less than 25% by weight. The use of the polyvinyl acetal resin in the laminating layer ensures good adhesion of the laminating layer to a substrate such as glass and allows the laminating layer to have suitable mechanical properties.

A degree of acetalization of the polyvinyl acetal resin (for example, the degree of butyralization of a polyvinyl butyral resin) may be 70% to 82% by weight. When the degree of acetalization is 70% by weight or more, high compatibility between the polyvinyl acetal resin and the plasticizer can be ensured. Meanwhile, when the degree of acetalization is 82% by weight or less, a reaction time required for preparing the polyvinyl acetal resin can be shortened.

A degree of acetylation (amount of acetyl groups) of the polyvinyl acetal resin may be 0.1% to 5.0% by weight. The use of the polyvinyl acetal resin in the laminating layer leads to high compatibility between a polyvinyl acetal resin and a plasticizer and an improvement in a moisture resistance of the laminating layer.

The plasticizer may be comprised in the laminating layer is not particularly limited and may be one known in the art. The laminating layer may comprise a kind of plasticizer or a combination of two or more plasticizers.

Examples of suitable plasticizers comprise organic ester plasticizers such as monobasic organic acid esters and polybasic organic acid esters, organic phosphate plasticizers, and organic phosphite plasticizers. The plasticizer may be used in a liquid form.

Examples of the monobasic organic acid esters comprise glycol esters obtained by reaction of glycols with monobasic organic acids. Examples of the glycols comprise triethylene glycol, tetraethylene glycol, and tripropylene glycol. Examples of the monobasic organic acids comprise butyric acid, isobutylic acid, caproic acid, 2-ethylbutyric acid, heptanoic acid, n-octanoic acid, 2-ethylhexanoic acid, n-nonanoic acid, and decanoic acid.

Examples of the polybasic organic acid esters comprise ester compounds of polybasic organic acids and C₄-C₈ linear or branched alcohols. Examples of the polybasic organic acids comprise adipic acid, sebacic acid, and azelaic acid.

Examples of the organic ester plasticizers comprise triethylene glycol di-2-ethylpropanoate, triethylene glycol di-2-ethylbutyrate, triethylene glycol di-2-ethylhexanoate, triethylene glycol dicaprylate, triethylene glycol di-n-octanoate, triethylene glycol di-n-heptanoate, tetraethylene glycol di-n-heptanoate, dibutyl sebacate, dioctyl azelate, dibutyl carbitol adipate, ethylene glycol di-2-ethylbutyrate, 1,3-propylene glycol di-2-ethylbutyrate, 1,4-butylene glycol di-2-ethylbutyrate, diethylene glycol di-2-ethylbutyrate, diethylene glycol di-2-ethylhexanoate, dipropylene glycol di-2-ethylbutyrate, triethylene glycol di-2-ethylpentanoate, tetraethylene glycol di-2-ethylbutyrate, diethylene glycol dicaprylate, dihexyl adipate, dioctyl adipate, hexyl cyclohexyl adipate, a mixture of heptyl adipate and nonyl adipate, diisononyl adipate, diisodecyl adipate, heptyl nonyl adipate, dibutyl sebacate, oil-modified sebacic alkyds, and a mixture of a phosphoric acid ester and an adipic acid ester. Other organic ester plasticizers may also be used. Other adipic acid esters may also be used.

Examples of the organic phosphate plasticizers comprise tributoxyethyl phosphate, isodecyl phenyl phosphate, and triisopropyl phosphate.

The plasticizer is preferably selected from the group consisting of triethylene glycol bis(2-ethylhexanoate) (3G8), tetraethylene glycol diheptanoate (4G7), triethylene glycol bis(2-ethylbutyrate) (3GH), triethylene glycol bis(2-heptanoate) (3G7), dibutoxyethoxyethyl adipate (DBEA), butyl carbitol adipate (DBEEA), dibutyl sebacate (DBS), bis(2-hexyladipate) (DHA), and combinations thereof. The plasticizer is more preferably selected from the group consisting of triethylene glycol di-2-ethylbutyrate, triethylene glycol di-2-ethylhexanoate, triethylene glycol di-n-heptanoate, and combinations thereof. The plasticizer may comprise triethylene glycol bis(2-ethylhexanoate) (3G8).

The resin layer 2 may further comprise another ultraviolet absorber in addition to the benzotriazole ultraviolet absorber. The additional ultraviolet absorber may be selected from the group consisting of metallic ultraviolet absorbers, metal oxide ultraviolet absorbers, benzophenone ultraviolet absorbers, triazine ultraviolet absorbers, malonate ultraviolet absorbers, oxalic acid anilide ultraviolet absorbers, benzoate ultraviolet absorbers, and combinations thereof.

The resin layer 2 or the laminating layer may comprise an antioxidant. The use of the antioxidant prevents or minimizes the occurrence of discoloration during formation of the resin layer or long-term use of the resin layer at high temperature and can prevent a decrease in the visible light transmittance of the resin layer. The resin layer 2 or the laminating layer may comprise a kind of antioxidant or a combination of two or more antioxidants.

Examples of such antioxidants comprise phenolic antioxidants, sulfur antioxidants, and phosphorus antioxidants. The phenolic antioxidants refer to antioxidants that have a phenol skeleton. The sulfur antioxidants refer to sulfur-containing antioxidants. The phosphorus antioxidants refer to phosphorus-containing antioxidants. The antioxidant is preferably a phenolic antioxidant or a phosphorus antioxidant.

Examples of the phenolic antioxidants comprise 2,6-di-t-butyl-p-cresol (BHT), butylhydroxyanisole (BHA), 2,6-di-t-butyl-4-ethylphenol, stearyl-β-(3,5-di-t-butyl-4-hydroxyphenyl)propionate, 2,2′-methylenebis(4-methyl-6-butylphenol), 2,2′-methylenebis(4-ethyl-6-t-butylphenol), 4,4′-butylidene-bis(3-methyl-64-butylphenol), 1,1,3-tris(2-methylhydroxy-5-t-butylphenyl)butane, tetrakis[methylene-3-(3′,5′-butyl-4-hydroxyphenyl)propionate]methane, 1,3,3-tris(2-methyl-4-hydroxy-5-t-butylphenol)butane, 1,3,5-trimethyl-2,4,6-tris(3,5-di-t-butyl-4-hydroxybenzyl)benzene, bis(3,3′-t-butylphenol)butyric acid glycol ester, and bis(3-t-butyl-4-hydroxy-5-methylbenzenepropanoic acid)ethylenebis(oxyethylene).

Examples of the phosphorus antioxidants comprise tridecyl phosphite, tris(tridecyl)phosphite, triphenyl phosphite, trinonyl phenyl phosphite, bis(tridecyl)pentaerythritol diphosphite, bis(decyl)pentaerythritol diphosphate, tris(2,4-di-t-butylphenyl)phosphite, bis(2,4-di-t-butyl-6-methylphenyl)ethyl ester phosphorous acid, and 2,2′-methylenebis(4,6-di-t-butyl-1-phenyloxy)(2-ethylhexyloxy)phosphorus.

Examples of commercially available products for the antioxidants comprise IRGANOX 245 (BASF), IRGAFOS 168 (BASF), IRGAFOS 38 (BASF), Sumilizer BHT (Sumitomo Chemical Co., Ltd.), H-BHT (Sakai Chemical Industry Co., Ltd.), and IRGANOX 1010 (BASF).

The resin layer (or laminating layer) may contain at least 0.025% by weight, at least 0.05% by weight or at least 0.1% by weight of the antioxidant, based on its total weight. The presence of the antioxidant in the amount defined above can further suppress discoloration of the resin layer (or laminating layer) and prevent a decrease in the visible light transmittance of the resin layer (or laminating layer). The content of the antioxidant may be 2% by weight or less, based on the total weight of the resin layer (or laminating layer). The use of the antioxidant in an amount exceeding 2% by weight does not contribute to further improvement of antioxidative effects.

The resin layer (or laminating layer) may optionally further comprise one or more additives selected from the group consisting of flame retardants, antistatic agents, pigments, dyes, dehumidifying agents, fluorescent whitening agents, infrared absorbers, and combinations thereof.

The thickness of the resin layer 2 is not particularly limited but may be 0.1 mm or more or 0.25 mm or more, which is suitable to ensure good penetration resistance/impact resistance. The thickness of the resin layer 2 may be 3 mm or less or 1.5 mm or less, which is required to reduce the weight of the light transmitting laminate and make the light transmitting laminate thin.

The thickness of the laminating layer may be 0.05 mm or more, 0.1 mm or more, 0.15 mm or more, or 0.3 mm or more, but 3 mm or less, 2 mm or less, 1.5 mm or less, or 1.0 mm or less.

There is no particular restriction on the method for forming the resin layer. The resin layer may be formed by any suitable method known in the art. For example, the resin layer may be formed by mixing and kneading the components and molding the mixture into a film. Extrusion molding suitable for continuous production is preferably used to form the resin layer. In this case, the resin layer can be formed into a co-extruded multilayer film.

There is no particular restriction on the method for mixing and kneading. For example, an extruder may be used for mixing and kneading. The use of an extruder is suitable for continuous production. It is more suitable to use a twin-screw extruder.

For instance, the resin layer may be formed into an extruded film by placing the composition in an extruder (e.g., a twin-screw extruder), melting the composition, and discharging the molten composition. In this case, the thickness of the resin layer is controlled through a T-die. The resin layer having a multi-layer structure may be formed by co-extrusion. First, the polyvinyl acetal resin composition described above for the surface layer and a different composition for the other layers, comprising the intermediate layer, are melt-extruded in different extruders. The extrudates are laminated through a suitable laminator such as a feed block or multi-manifold. The laminate is molded into a co-extruded film through a T-die.

The resin layer 2, optionally together with one or more other films, may be bonded to the light transmitting layers such as glass plates.

The resin layer 2 bonded to the light transmitting layers such as glass plates may comprise a single laminating layer (see FIG. 1). Alternatively, the resin layer 2 may have a multilayer structure comprising three or more layers. In this case, the resin layer 2 may comprise a first laminating layer 21 sharing one surface of the resin layer 2 and a second laminating layer 22 opposite the first laminating layer and sharing the other surface of the resin layer 2. The first laminating layer 21 and the second laminating layer 22 are in direct contact with and bonded to the first light transmitting layer 3 and the second light transmitting layer 4, respectively (see FIG. 2). The laminating layer refers collectively to the first laminating layer 21 and the second laminating layer 22. The laminating layer has the characteristics described above.

For the resin layer 2 having a multilayer structure, an additional layer may be interposed between the first laminating layer 21 and the second laminating layer 22. The additional layer may be a functional layer 23.

The functional layer 23 may be a sound insulating layer. When the resin layer 2 is used as a laminating film, the sound insulating layer may impart the resin layer 2 with sound insulating properties to block external noise.

The functional layer 23 may be a head up display (HUD) functional layer that functions to prevent the formation of a double image on the laminating film. The HUD functional layer may be a wedge layer (not illustrated) that has an overall wedge-shaped cross section, but is not limited thereto.

The functional layer 23 may be a colored layer. The colored layer may be formed over the entire area of the resin layer. Alternatively, the colored layer may be formed on only a partial area of the resin layer to form a shade band.

A light transmitting laminate 1 according to a further embodiment disclosed herein comprises a first light transmitting layer 3, a resin layer 2 positioned on one surface of the first light transmitting layer, and a second light transmitting layer 4 positioned on the resin layer. That is, the resin layer is arranged between the first light transmitting layer and the second light transmitting layer.

The first and second light transmitting layers 3 and 4 may be glass plates but are not limited thereto. Alternatively, light transmitting panels or plastic substrates (for example, polyester films) may be used as the first and second light transmitting layers 3 and 4.

The resin layer 2 comprises a laminating layer containing a polyvinyl acetal resin, a plasticizer, and a bonding strength modifier. The bonding strength modifier comprises a butylated hydroxytoluene type metal complex.

The resin layer 2 is the same as that described above and a detailed description thereof will be omitted.

The light transmitting laminate 1 may have an average whitening distance variation of 5 mm or less, as measured before and after storage at 65° C. and 95% RH for 2 weeks. This small variation means that the light transmitting laminate has good moisture resistance even in a harsh environment.

A vehicle (not illustrated) according to another embodiment disclosed herein comprises the light transmitting laminate 1 as a windshield.

The vehicle may be any vehicle that uses a windshield. The vehicle is typically a motor vehicle.

The vehicle comprises a body part, a driving part (e.g., an engine) mounted in the body part, driving wheels rotatably mounted in the body, connectors connecting the driving wheels and the driving part, and a windshield mounted on a portion of the body part to block wind from the outside. The light transmitting laminate 1 is used as the windshield.

The construction of the light transmitting laminate 1 and the characteristics of the components of the light transmitting laminate 1 are the same as those described above and a detailed description thereof will be omitted.

Example embodiments will be explained in more detail with reference to the following examples. However, these examples are merely illustrative to assist in understanding example embodiments and are not intended to limit the scope of example embodiments.

The following materials were used in Examples 1-2 and Comparative Examples 1-2.

Polyvinyl butyral resin: degree of polymerization=1,700, degree of saponification=99, amount of hydroxyl groups=19.7 wt %, amount of butyral groups=79.6 wt %, amount of acetyl groups=0.7 wt %

Plasticizer: triethylene glycol bis(2-ethylhexanoate) (3G8)

Additive: a mixture of 0.1 parts by weight of pentaerythritol tetrakis(3-(3,5-di-tert-butyl-4-hydroxyphenyl)propionate (Irganox1010, BASF) and 0.3 parts by weight of 2-(2H-benzotriazol-)2-yl)-4,6-bis(1-methyl-1-phenylethyl)phenol (TINUVIN-234, BASF)

Bonding strength modifiers: magnesium acetate, potassium acetate, the magnesium complex of Formula 1 wherein R₁ and R₂ are acetyl groups, and the magnesium complex of Formula 1 wherein R₁ and R₂ are butyrate groups. The amounts of the magnesium complexes used were shown in Table 1.

### EXAMPLE 1

27 wt % of the plasticizer (3G8), 0.4 wt % of the additive, 0.025 wt % of magnesium acetate as one of the bonding strength modifiers, and 0.01 wt % of the magnesium complex A of Formula 1 (wherein R₁ and R₂ are acetyl groups) as one of the bonding strength modifiers were added to 72.565 wt % of the polyvinyl butyral resin. The mixture was extruded in a twin-screw extruder and passed through a T-die to form a laminating film having a width of 1 m and a total thickness of 780 μm.

### EXAMPLE 2

The procedure of Example 1 was repeated except that 0.025 wt % of magnesium acetate and 0.01 wt % of the magnesium complex B of Formula 1 wherein R₁ and R₂ are butyrate groups as the bonding strength modifiers were used.

### COMPARATIVE EXAMPLE 1

27 wt % of the plasticizer (3G8), 0.4 wt % of the additive, and 0.03 wt % of magnesium acetate as one of the bonding strength modifiers were added to 72.57 wt % of the polyvinyl butyral resin. The mixture was extruded in a twin-screw extruder and passed through a T-die to form a laminating film having a width of 1 m and a total thickness of 780 μm.

### COMPARATIVE EXAMPLE 2

The procedure of Comparative Example 1 was repeated except that 0.03 wt % of potassium acetate was used as a bonding strength modifier.

TABLE 1

| | | | Compara- | Compara- |
|---|---|---|---|---|
| | | | tive | tive |
| | | | Ex- | Ex- |
| | Example 1 | Example 2 | ample 1 | ample 2 |
| Bonding | Magnesium | Magnesium | Mag- | Potas- |
| strength | acetate | acetate | nesium | sium |
| modifier 1 | | | acetate | acetate |
| Bonding | Magnesium | Magnesium | — | — |
| strength | complex A | complex B | | |
| modifier 2 | | | | |
| R₁ | Acetyl group | Butyrate group | — | — |
| R₂ | Acetyl group | Butyrate group | — | — |
| Bonding | 0.025 | 0.025 | 0.03 | 0.03 |
| strength | | | | |
| modifier | | | | |
| 1 (wt %)* | | | | |
| Bonding | 0.01 | 0.01 | 0 | 0 |
| strength | | | | |
| modifier | | | | |
| 2 (wt %)* | | | | |

### TEST EXAMPLE 1

The physical properties of the laminating films formed in Examples 1-2 and Comparative Examples 1-2 were evaluated as follows. The results are shown in Table 2.

(1) Metal Content Evaluation: ICP-OES Analysis

The amount (ppm) of residual metal in each of the resin layers formed in Examples 1-2 and Comparative Examples 1-2 was detected by ICP-OES analysis (730-ES, Agilent).

(2) Hydrophobicity Evaluation

Preparation of Samples for Evaluation

A sample having a size of 15 cm (w)×15 cm (l) was taken from the widthwise central portion of each of the resin layers formed in Examples 1-2 and Comparative Examples 1-2. The sample was interposed between two Teflon sheets (size: 20 cm×20 cm). The Teflon sheet/sample/Teflon sheet structure was heated in a laminator at 140° C. and 1 atm for 10 min to remove the surface pattern.

Surface Free Energy Measurement

Each of the samples for evaluation was allowed to stand at 20° C. and 20% RH for 72 h. After removal of the Teflon sheets, the surface free energy of the resin layer was measured by the following procedure. First, a mobile surface analyzer (MSA, KRUSS) was placed on the surface of the resin layer and the measurement button was pressed down. Then, the surface free energy, non-polarity, and polarity calculated and displayed by the OWRK method were recorded. The same measurement was repeated 7 times for each parameter and the average of 5 measured values other than the upper and lower limits.

Hydrophobicity Calculation

The hydrophobicity of each of the samples was calculated based on the measured non-polarity and polarity. Specifically, the hydrophobicity was defined as a value obtained by dividing the non-polarity, which is a value indicative of non-affinity for a polar solvent such as water, by the polarity, which is a value indicative of affinity for a polar solvent such as water. That is, the hydrophobicity was calculated by Equation 1:

Hydrophobicity=non-polarity/polarity (1)

The hydrophobicity was taken to one decimal place from the calculated value.

Characterization of the Resin Layers

Gel permeation chromatography (GPC) was used to determine the characteristics of the samples for evaluation. The samples with different hydrophobicities were analyzed using an ultraviolet detector (UVD) to obtain curves as a function of elution time. A comparison of the curves was performed in the elution time range of 26-28 min (RT) where the bonding strength modifier was possibly present.

First, each sample was pre-treated for gel permeation chromatography.

0.1 g of the sample for evaluation was diluted with 10 g of THF. The dilution was allowed to stand at room temperature for 12 h to sufficiently dissolve and homogenize the sample. Thereafter, 100 microliters of the solution was loaded onto a column at a rate of 1.0 ml/min. The UV detector was operated at 230 nm. The column was an assembly of TSKgel guard column (6.0 mm ID×4 cm, particle size 7 μm), TSKgel G1000HXL (7.8 mm ID×30 cm, particle size 5 μm, exclusion limit 1,000 Da), TSKgel G2500HXL (7.8 mm ID×30 cm, particle size 5 μm, exclusion limit 2.0×10⁴ Da), and TSKgel G3000HXL (7.8 mm ID×30 cm, particle size 5 μm, exclusion limit 6.0×10⁴ Da), all of which are available from TOSOH. The measured values were analyzed and plotted using Agilent Chemstation OpenLab. CDS.

The results of GPC analysis revealed that the peak characteristics of the resin layers with different hydrophobicities were different in the detection time range of 26-28 min FIG. 4 shows gel permeation chromatograms of the samples taken from the resin layers of Example 2 (EX2, left) and Comparative Example 1 (C.EX1, right) in the detection time range of 26-28 min. For each sample, two peaks were observed in the corresponding range. For the sample from the resin layer of Example 2, the intensity of the earlier peak was larger than that of the later peak. For the sample from the resin layer of Comparative Example 2, the intensity of the later peak was larger than that of the earlier peak. In conclusion, the resin layer with higher hydrophobicity had at least two peaks wherein the intensity of the earlier peak was larger than that of the later peak, unlike the resin layer with lower hydrophobicity.

(3) Evaluation of Shelf Moisture Resistance

Preparation of Samples for Evaluation

Each of the resin layers formed in Examples 1-2 and Comparative Examples 1-2 was cut into two samples, each of which had a size of 50 cm (w)×50 cm (l). A PE embo film was placed on the upper and lower surfaces of the sample to create an environment similar to that for storage of a roll sample.

Conditioning

One of the samples for evaluation was stored at 20° C. and 20% RH for 30 days (storage conditions A) and the other sample was stored at 30° C. and 80% RH for 30 days (storage conditions B).

Evaluation of Shelf Yellowness Index Difference

The yellowness index variation of each sample in different storage environments was evaluated. To this end, a sample having a size of 10 cm (w)×10 cm (l) was taken from the conditioned sample. The sample was interposed between two Teflon sheets (size: 20 cm×20 cm). The Teflon sheet/sample/Teflon sheet structure was heated in a laminator at 140° C. and 1 atm for 10 min to remove the surface pattern. Five sites on the surface of the sample were randomly selected, and their yellowness indices were measured by the ASTM E313 method and averaged. The difference between the yellowness indices after storage under the storage conditions A (Shelf_YI_A) and under the storage conditions B (Shelf_YI_B) was calculated by Equation 2:

Shelf yellowness index difference=Shelf_YI_B−Shelf_YI_A (2)

Evaluation of Shelf Moisture Resistance

The shelf moisture resistance was evaluated by substituting the measured shelf yellowness index difference into Equation 3:

Shelf moisture resistance=(Shelf yellowness index difference)×100/Metal content (ppm) (3)

The shelf moisture resistance was judged to be “good” when <3, “fair” when ranging between 3 and 4, and “poor” when >4.

(4) Evaluation of Pummel Bonding Strength

Preparation of Light Transmitting Laminates for Measurement

Each of the resin layers formed in Examples 1-2 and Comparative Examples 1-2 was allowed to stand at 20° C. and 30% RH for 1 week. Thereafter, the resin layer was cut into a sample having a size of 100 mm (w)×150 mm (l). Two 2.1 T (T: mm, the same applied below) sheets of clear glass was placed on both surfaces of the sample. The glass-sample-glass structure was preliminarily bonded in a vacuum laminator at 150° C. and 1 atm for 20 sec and finally bonded by heating from room temperature to 140° C. for 25 min and maintaining at 140° C. for 25 min in an autoclave to obtain a light transmitting laminate specimen.

Measurement of Pummel Bonding Strength

The specimen was cooled at −20° C. for 4 h and continuously hit with a hammer. The amount of glass remaining in the resin layer was measured. The results were classified into grades from 0 to 8 depending on the amount of glass bonded to and remaining in the resin layer after hitting. The lowest grade 0 was defined when the glass was completely peeled off from the resin layer after hitting and the highest grade 8 was defined when the glass remained unpeeled after hitting. Grades 0 to 8 were scored as pummel values (P_ctr) from 0 to 8, respectively.

The presence of the glass on the resin layer even after hitting indicates high strength of the resin layer and the removal of the glass from the resin layer means low bonding strength of the resin layer.

Calculation of Effective Bonding Strength Reduction Depending on Metal Content

The effective bonding strength reduction of the resin layer depending on the metal content was calculated by substituting the pummel value (P_ctr) into Equation 4:

Effective bonding strength reduction=[100×{8−P_ctr (pummel value)}]/metal content (ppm) (4)

(5) Measurement of Yellowness Index Variation

Evaluation of Yellowness Index Variation

A light transmitting laminate sample was prepared according to the method described in “Preparation of light transmitting laminates for measurement” of (4) Evaluation of pummel bonding strength. The sample was allowed to stand in a thermo-hygrostat chamber at 65° C. and 95% RH for 2 weeks. After withdrawal of the sample, the yellowness index variation before and after storage was measured according to the ASTM E313 testing standard. The yellowness index after storage (YI_{final}) and the yellowness index before storage (YIᵢₙᵢₜᵢₐₗ) were measured and the difference was defined as the yellowness index variation (d−YI) (refer to Equation 6).

d−YI=YI_{final}−YIᵢₙᵢₜᵢₐₗ (6)

The sample was judged to pass the test when the yellowness index variation was ≤3 and fail the test when the yellowness index variation was >3.

(6) Measurement of Whitening Distance

Preparation of Light Transmitting Laminate for Evaluation

A light transmitting laminate sample was prepared according to the method described in “Preparation of light transmitting laminates for measurement” of (4) Evaluation of pummel bonding strength.

Evaluation of Whitening Distance

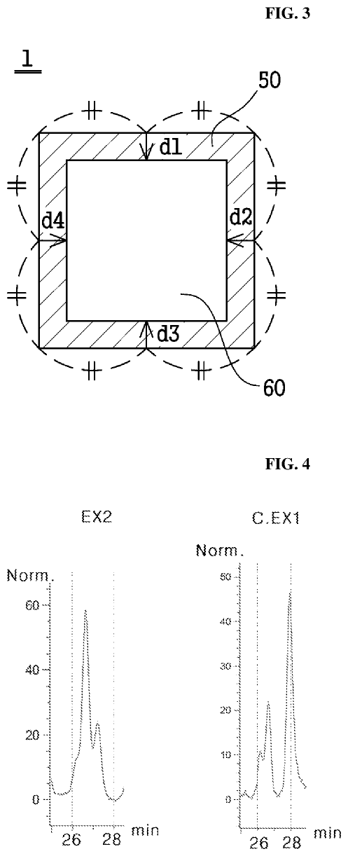

FIG. 3 illustrates the measurement of whitening distances. The light transmitting laminate sample 1 was allowed to stand in a thermo-hygrostat chamber at 65° C. and 95% RH for 2 weeks. After withdrawal of the sample, the sample was divided into a portion 50 where haze occurred and a portion 60 where haze did not occur. The distances d1, d2, d3, and d4 from the centers of the four sides of the sample to locations where haze occurred were measured, and averaged. The average value was defined as an average whitening distance variation (see Equation 7).

Average whitening distance variation=(d1+d2+d3+d4)÷4 (7)

The sample was judged to pass the test when the average whitening distance variation was ≤5 mm and fail the test when the average whitening distance variation was >5 mm.

TABLE 2

| | | | Comparative | Comparative |
|---|---|---|---|---|
| | Example 1 | Example 2 | Example 1 | Example 2 |
| Metal | Magnesium | Magnesium | Magnesium | Potassium |
| Metal content (ppm) | 52 | 51 | 51 | 114 |
| Hydrophobicity | 4.2 | 4.8 | 3.2 | 2.1 |
| Shelf yellowness index difference | 1.4 | 1.6 | 2.1 | 7.2 |
| Shelf moisture resistance | 2.7 | 3.1 | 4.1 | 6.3 |
| Judgement of shelf moisture resistance | Good | Good | Fair | Poor |
| Pummel value (P_ctr) | 4 | 3 | 6 | 3 |
| Effective bonding strength reduction (/ppm) | 7.6 | 9.8 | 3.9 | 4.4 |
| Yellowness index variation | pass | pass | pass | pass |
| Average whitening distance variation | pass | pass | pass | fail |

As can be seen from the results in Table 2, the samples of Examples 1 and 2 had better shelf moisture resistance and less effective bonding strength reduction than Comparative Example 1 despite their similar magnesium contents. These results are thought to be because the highly hydrophobic resin layers prevented the penetration of moisture in the air.

The sample of Comparative Example 2 in which the potassium salt was used as a bonding strength modifier had similar bonding strength control effects to the samples of Examples 1 and 2 in which the metal complex was used as a bonding strength modifier, but its shelf moisture resistance was judged to be “poor” due to its low hydrophobicity and high shelf yellowness index difference. These results are thought to be because the bonding strength modifier was used in an excessive large amount to achieve the same bonding strength control effects.

The yellowness index variations of the samples of Examples 1-2 and Comparative Examples 1-2 in the form of light transmitting laminates (laminated glass) were judged to pass the test. These results are thought to be because the glass bonded to both surfaces of the sample was not directly exposed to moisture in the air to reduce the influence of moisture resistance on the yellowness index variation depending on the type of the bonding strength modifier. However, the average whitening distance variation of the laminated glass of Comparative Example 2 was judged to fail the test because moisture easily penetrated into the laminated glass of Comparative Example 2 having the lowest hydrophobicity along the four side edges of the laminated glass. These results are thought to be because the use of the highly hydrophobic resin layer as a laminating film ensures not only good shelf moisture resistance but also improved moisture resistance after laminating.

Hereinabove, the preferred embodiments of example embodiments have been explained in detail, but the scope of example embodiments should not be limited thereto, and various modifications and improvements made by a person of ordinary skill in the art with using a basic concept defined by the following claims should also be construed to belong to the scope of example embodiments.

What is claimed is:

1. A resin layer comprising at least one laminating layer containing a polyvinyl acetal resin, a plasticizer, and a bonding strength modifier
wherein the surface of the laminating layer comprises a portion having a hydrophobicity of 3.5 to 10, as calculated by Equation 1:
Hydrophobicity=Non-polarity/polarity (1)
where the non-polarity represents a non-polar fraction of a surface free energy of the laminating layer and the polarity represents a polar fraction of the surface free energy of the laminating layer.

2. The resin layer according to claim 1,
wherein the laminating layer has two or more peaks in the detection time range of 26 to 28 minutes (RT) in an ultraviolet detector (UVD) of a gel permeation chromatography (GPC) system.

3. The resin layer according to claim 1,
wherein the laminating layer has a shelf yellowness index difference of less than 2, as calculated by Equation 2:
Shelf yellowness index difference=Shelf_YI_B−Shelf_YI_A (2)
where Shelf_YI_B represents a yellowness index of the laminating layer measured by the ASTM E313 method after storage at 30° C. and 80% RH for 30 days and Shelf YI_A represents a yellowness index of the laminating layer measured by the ASTM E313 method after storage at 20° C. and 20% RH for 30 days.

4. The resin layer according to claim 3, wherein the laminating layer has a shelf moisture resistance of 0 to 4, as calculated by Equation 3:
Shelf moisture resistance=(Shelf yellowness index difference)×100/Metal content (3)
where the metal content represents a content (ppm) of a metal in the laminating layer.

5. The resin layer according to claim 1, wherein the laminating layer has an effective bonding strength reduction of 5 to 15, as calculated by Equation 4:
Effective bonding strength reduction={8−P_ctr (pummel value)}×100/metal content (4)
where P_ctr is a pummel value of the laminating layer and the metal content is a content (ppm) of a metal in the laminating layer.

6. The resin layer according to claim 1, wherein the resin layer is a laminating interlayer.

7. A light transmitting laminate comprising
a resin layer, a first light transmitting layer, and a second light transmitting layer
wherein the resin layer is arranged between the first light transmitting layer and the second light transmitting layer and comprises at least one laminating layer containing a polyvinyl acetal resin, a plasticizer, and a bonding strength modifier and
wherein a surface of the laminating layer comprises a portion having a hydrophobicity of 3.5 to 10, as calculated by Equation 1:
Hydrophobicity=Non-polarity/polarity (1)
where the non-polarity represents a non-polar fraction of a surface free energy of the laminating layer and the polarity represents a polar fraction of the surface free energy of the laminating layer.

8. The light transmitting laminate according to claim 7,
wherein the light transmitting laminate has a yellowness index variation of 3.0 or less before and after storage in a thermo-hygrostat chamber at 65° C. and 95% RH for 2 weeks.

9. The light transmitting laminate according to claim 7,
wherein the light transmitting laminate has an average whitening distance variation of 5 mm or less, as measured before and after storage at 65° C. and 95% RH for 2 weeks.

10. A vehicle comprising the light transmitting laminate according to claim 7.
